(19) United States
(12) Patent Application Publication
(10) Pub. No.: US 2019/0017462 A1
(43) Pub. Date: Jan. 17, 2019

(54) Fuel Injection Control

(71) Applicant: Continental Automotive GmbH, Hannover (DE)

(72) Inventors: Gerhard Eser, Hemau (DE); Erwin Achleitner, Obertraubling (DE); Florian Kleiner, Kehlheim (DE)

(73) Assignee: Continental Automotive GmbH, Hannover (DE)

(21) Appl. No.: 16/081,326

(22) PCT Filed: Feb. 9, 2017
(86) PCT No.: PCT/EP2017/052863

§ 371 Date: Aug. 30, 2018

(30) Foreign Application Priority Data
Mar. 2, 2016 (DE) 10 2016 203 436.7

(51) Int. Cl. F02D 41/40; F02D 41/30; F02D 35/02

(52) U.S. Cl. CPC F02D 41/401; F02D 2041/389; F02D 35/025; F02D 41/3011

(57) ABSTRACT

Various embodiments may include a method for setting injection timing for injection of a fuel into a combustion chamber of a cylinder of an internal combustion engine including: determining a torque; determining a speed; determining a cylinder wall temperature; selecting the injection timing based at least on the cylinder wall temperature, the torque, and the speed; and controlling an injection of fuel into the combustion chamber using the selected injection timing.

### CROSS-REFERENCE TO RELATED APPLICATIONS

This application is a U.S. National Stage Application of International Application No. PCT/EP2017/052863 filed Feb. 9, 2017, which designates the United States of America, and claims priority to DE Application No. 10 2016 203 436.7 filed Mar. 2, 2016, the contents of which are hereby incorporated by reference in their entirety.

### TECHNICAL FIELD

The present disclosure relates to internal combustion engines. Various embodiments may include a method for setting an injection time for the injection of a fuel into a combustion chamber of a cylinder of an internal combustion engine.

### BACKGROUND

With the increasing stringency of legal requirements with regard to emissions of limited pollutants, it is necessary for the fuel to be introduced exactly at the correct time and in the ideal manner into the combustion chamber. DE 10 2006 010 094 A1 discloses a method for temperature determination in the exhaust system of an internal combustion engine having a control device, wherein, on the basis of at least one operating variable, a temperature or a temperature profile of an exhaust gas in the exhaust system is calculated from an energy balance. DE 10 2008 020 933 B4 discloses a method for checking the plausibility of a temperature measurement in an internal combustion engine.

DE 44 33 631 A1 discloses a method for forming a signal relating to a temperature in the exhaust system of an internal combustion engine. With the method, it is for example possible for a signal for the exhaust temperature upstream of the catalytic converter, or for a signal for the temperature in the catalytic converter or a signal for the temperature downstream of the catalytic converter, to be formed.

DE 10 2007006 341 A1 discloses a method for controlling an internal combustion engine in motor vehicles, with determination of various setting parameters by means of an electronic control unit in a manner dependent on operating parameters, wherein the setting parameter is formed from a base value and at least one corrective value, and a corrective value is determined in a manner dependent on an estimated combustion chamber wall temperature.

### SUMMARY

The teachings of the present disclosure may provide a reduction in emissions from internal combustion engines. For example, some embodiments may include a method for ascertaining an injection time for the injection of a fuel into a combustion chamber of a cylinder of an internal combustion engine, in which method: a torque (M) of the internal combustion engine is ascertained, a speed (N) of the internal combustion engine is ascertained, a cylinder wall temperature (ZT) of the cylinder is ascertained, and the injection time is ascertained in a manner dependent on the cylinder wall temperature (ZT), the torque (M) and the speed (N). In some embodiments, a piston crown temperature of the cylinder is ascertained, and the injection time is ascertained in a manner dependent on the piston crown temperature.

In some embodiments, a first characteristic map is made available which is representative of a characteristic map, provided for an internal combustion engine in a first operating mode, for the ascertainment of the injection time, and a first value of the first characteristic map is ascertained in a manner dependent on the torque (M) and the speed (N), the first value is weighted in a manner dependent on the cylinder wall temperature (ZT), and the injection time is ascertained in a manner dependent on the weighted first value.

In some embodiments, a second characteristic map is made available which is representative of a characteristic map, provided for an internal combustion engine in a second operating mode which differs from the first operating mode, for the ascertainment of the injection time, and a second value of the second characteristic map is ascertained in a manner dependent on the torque (M) and the speed (N), the second value is weighted in a manner dependent on the cylinder wall temperature (ZT), and the injection time is ascertained in a manner dependent on the weighted second value.

In some embodiments, the first characteristic map is representative of a characteristic map, provided for an internal combustion engine in a normal operating mode, for the ascertainment of the injection time, and the second characteristic map is representative of a characteristic map, provided for an internal combustion engine during a load alteration, for the ascertainment of the injection time.

In some embodiments, the cylinder wall temperature (ZT) is ascertained by means of a predefined cylinder wall temperature model.

In some embodiments, the cylinder wall temperature model is a thermodynamic temperature model.

In some embodiments, the ascertained cylinder wall temperature (ZT) is representative of a dynamic cylinder wall temperature which is ascertained in a manner dependent on a steady-state cylinder wall temperature.

In some embodiments, the cylinder wall temperature (ZT) is ascertained in a manner dependent on an ascertained cylinder pressure, an ascertained swept volume of the cylinder, an ascertained air mass and an ascertained indicated engine torque.

In some embodiments, the cylinder wall temperature (ZT) is ascertained in a manner dependent on an ascertained exhaust-gas temperature.

In some embodiments, the cylinder wall temperature model comprises the modular intermediate variables of mean gas temperature in the cylinder chamber, indicated mean pressure of the cylinder, heat transfer coefficient in the combustion chamber, and steady-state cylinder wall temperature.

As another example, some embodiments include an apparatus for ascertaining an injection time for the injection of a fuel into a combustion chamber of a cylinder of an internal combustion engine, wherein the apparatus is designed to carry out a method as described above.

### BRIEF DESCRIPTION OF THE DRAWINGS

Exemplary embodiments of the teachings herein are explained in more detail herein below by means of the schematic drawings. In the drawings:

FIG. 1 shows a flow diagram relating to the ascertainment of an injection time, according to the teachings of the present disclosure;

FIG. 2 shows a further flow diagram relating to the ascertainment of an injection time, according to the teachings of the present disclosure; and

FIG. 3 shows a graph with values of ascertained cylinder wall temperatures, according to the teachings of the present disclosure.

Elements of the same design or function are denoted by the same reference designations throughout the figures.

### DETAILED DESCRIPTION

Some embodiments may include a method for calculating or determining an injection time for the injection of a fuel into a combustion chamber of a cylinder of an internal combustion engine. Some embodiments may include an apparatus for determining and implementing an injection time for the injection of a fuel into a combustion chamber of a cylinder of an internal combustion engine.

In some embodiments, a torque of the internal combustion engine is ascertained. A speed of the internal combustion engine is ascertained. A cylinder wall temperature of the cylinder is ascertained. The injection time is ascertained in a manner dependent on the cylinder wall temperature, the speed and the torque. Subsequently, the injection of the fuel into the combustion chamber of the cylinder of the internal combustion engine can be controlled in a manner dependent on the ascertained injection time.

The torque may also be referred to as load torque or as load. If the injection time is determined only by parameters such as load and speed, then these parameters are applicable only to certain combustion chamber temperatures. In the event of a change in the temperature, it is for example the case that the vaporization behavior of the fuel changes, and incomplete combustion occurs. The result is an exceedance of the particle limit values. Alternatively, the injection time can be ascertained in a manner dependent on a coolant temperature. Said temperature however does not constitute the reference variable that is relevant in the combustion chamber.

By means of the above method, it is possible, through the use of the cylinder wall temperature, to achieve an improvement in emissions, in particular a reduction in the particle count and particle size, in particular in relation to an ascertainment in a manner dependent on the coolant temperature.

In some embodiments, a piston crown temperature of the cylinder is ascertained, and the injection time is ascertained in a manner dependent on the piston crown temperature. The piston crown temperature can be ascertained for example by means of a suitable model.

In some embodiments, a first characteristic map is made available which is representative of a characteristic map, provided for an internal combustion engine in a first operating mode, for the ascertainment of the injection time. A first value of the first characteristic map is ascertained in a manner dependent on the torque and the speed. The first value is weighted in a manner dependent on the cylinder wall temperature. The injection time is ascertained in a manner dependent on the weighted first value. In this way, an injection time ascertained in a manner dependent on the torque and the speed can be easily adapted in a manner dependent on the cylinder wall temperature.

In some embodiments, a second characteristic map is made available which is representative of a characteristic map, provided for an internal combustion engine in a second operating mode which differs from the first operating mode, for the ascertainment of the injection time. A second value of the second characteristic map is ascertained in a manner dependent on the torque and the speed. The second value is weighted in a manner dependent on the cylinder wall temperature. The injection time is ascertained in a manner dependent on the weighted second value. In this way, in particular with the use of the first and second characteristic map, a selection between two parameter sets, or a changeover from one parameter set to the other parameter set, can be easily performed.

In some embodiments, the first characteristic map is representative of a characteristic map, provided for an internal combustion engine in a normal operating mode, for the ascertainment of the injection time, and the second characteristic map is representative of a characteristic map, provided for an internal combustion engine during a load alteration, for the ascertainment of the injection time. In particular in the event of a load alteration, a parameter set for low emissions is necessary, which differs from a parameter set for a normal operating mode. In this way, a changeover function between the first characteristic map and the second characteristic map can be easily achieved.

In some embodiments, the cylinder wall temperature is ascertained by means of a predefined cylinder wall temperature model. In this way, no reference sensor is needed. Through the use of a cylinder wall temperature model, the real cylinder wall temperature can be replicated very exactly. In some embodiments, the cylinder wall temperature model is a thermodynamic temperature model. In some embodiments, a thermodynamic model is based for example on the first law of thermodynamics and the real cylinder wall temperature can be replicated very exactly.

In some embodiments, the ascertained cylinder wall temperature is representative of a dynamic cylinder wall temperature which is ascertained in a manner dependent on a steady-state cylinder wall temperature. Through the ascertainment of a dynamic cylinder wall temperature, the thermal inertia of the cylinder head and of the engine block can be taken into consideration, such that the real cylinder wall temperature can be replicated very exactly.

In some embodiments, the cylinder wall temperature is ascertained in a manner dependent on an ascertained cylinder pressure, an ascertained swept volume of the cylinder, an ascertained air mass and an ascertained indicated engine torque. These variables, that is to say the cylinder pressure, the swept volume of the cylinder, the air mass and the indicated engine torque, can be very easily determined by means of normally already existing sensor arrangements and/or by means of engine data, such that, in this way, the cylinder wall temperature can be realized very easily and inexpensively.

In some embodiments, the cylinder wall temperature is ascertained in a manner dependent on an ascertained exhaust-gas temperature. Through the ascertainment in a manner dependent on an ascertained exhaust-gas temperature, the cylinder wall temperature can be determined very exactly. In some embodiments, the cylinder wall temperature may also be ascertained independently of the exhaust-gas temperature, that is to say the exhaust-gas temperature is not necessary for the determination of the cylinder wall temperature. It is thus also the case that no exact modeling of the exhaust-gas temperature, or an exhaust-gas temperature sensor, is needed.

In some embodiments, the cylinder wall temperature model comprises the modular intermediate variables of mean gas temperature in the cylinder chamber, indicated mean pressure of the cylinder, heat transfer coefficient in the combustion chamber, and steady-state cylinder wall temperature. The advantage of such a cylinder wall temperature model lies in the modular physical modelling. It is thus possible for intermediate variables to be determined in a component-dependent manner. This permits straightforward calibration of the cylinder wall temperature, because no multi-dimensional dependencies have to be determined in characteristic maps for the ascertainment of the cylinder wall temperature.

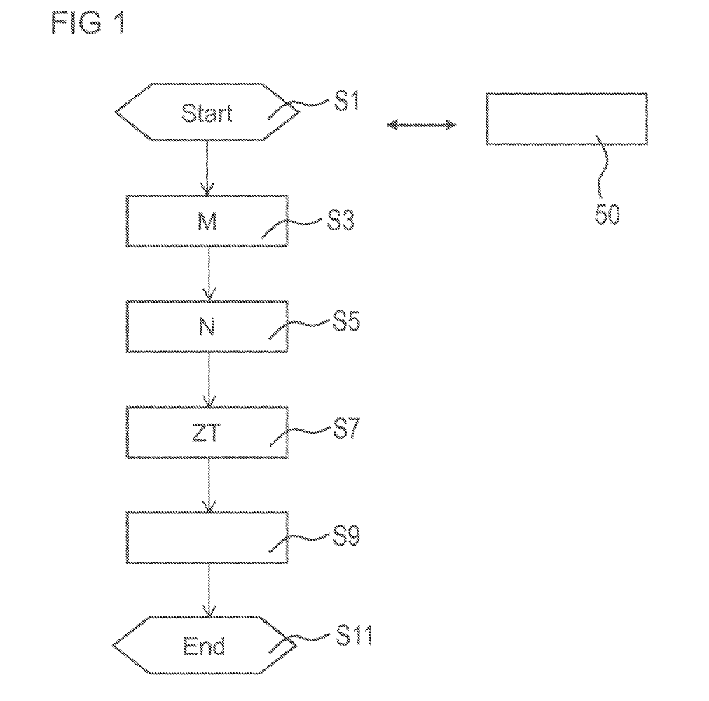

FIG. 1 shows a flow diagram of a program for ascertaining an injection time for the injection of a fuel into a combustion chamber of a cylinder of an internal combustion engine. The program may be executed for example by a control apparatus 50. For this purpose, the control apparatus 50 has, in some embodiments, a processing unit, a program and data memory and, for example, one or more communication interfaces. The program and data memory and/or the processing unit and/or the communication interfaces may be formed in a single module and/or may be distributed between several modules. For this purpose, the program, in particular, is stored in the data and program memory of the control apparatus 50. The control apparatus 50 may also be referred to as an apparatus for ascertaining the injection time.

In a step S1, the program is started, and variables are initialized as necessary. In a step S3, a torque M of the internal combustion engine is ascertained. In a step S5, a speed N of the internal combustion engine is ascertained. In a step S7, a cylinder wall temperature ZT of the cylinder is ascertained.

In a step S9, the injection time is ascertained in a manner dependent on the cylinder wall temperature ZT, the torque M and the speed N. In a step S11, the program is ended, and may be started again in the step S1 as necessary. Alternatively, the program is continued further in the step S3, and is not ended.

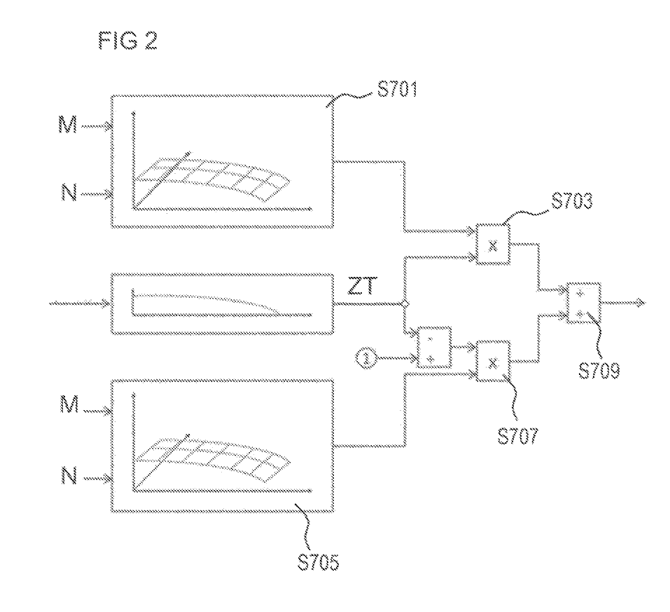

FIG. 2 shows a further flow diagram for the ascertainment of an injection time; in particular, FIG. 2 shows a more detailed example of the step S7. Here, a first characteristic map is made available which is representative of a characteristic map, provided for an internal combustion engine in a first operating mode, for the ascertainment of the injection time. In a step S701, a first value of the first characteristic map is ascertained in a manner dependent on the torque M and the speed N.

In a step S703, the first value is weighted in a manner dependent on the cylinder wall temperature ZT, for example by virtue of the cylinder wall temperature ZT being normalized and multiplied by the first value.

In some embodiments, a second characteristic map is made available which is representative of a characteristic map, provided for an internal combustion engine in a second operating mode which differs from the first operating mode, for the ascertainment of the injection time. In a step S705, a second value of the second characteristic map is ascertained in a manner dependent on the torque M and the speed N.

In a step S707, the second value is weighted in a manner dependent on the cylinder wall temperature ZT, for example by virtue of the cylinder wall temperature ZT being normalized and subtracted from the value 1, and the result thereof being multiplied by the second value.

In a step S709, the injection time is ascertained in a manner dependent on the weighted first value and/or in a manner dependent on the weighted second value, for example by virtue of the first value being added to the second value. The cylinder wall temperature is ascertained for example by means of a predefined cylinder wall temperature model.

For the ascertainment of the cylinder wall temperature model, it is for example possible for the first law of thermodynamics to be applied:

$$\frac{dU}{dCRK} = \frac{{dQ}_{fuel}}{dCRK} + \frac{{dQ}_{W}}{dCRK} + \frac{{dW}_{t}}{dCRK} + \frac{{dH}_{inlet}}{dCRK} + \frac{{dH}_{exhaust}}{dCRK} + \frac{{dH}_{blowby}}{dCRK} .$$

The sum of the heat supplied by means of the fuel

$$\frac{{dQ}_{fuel}}{dCRK} = \frac{{dm}_{fuel}}{dCRK} * {H}_{U}$$

corresponds to the wall heat flow

$$\frac{{dQ}_{W}}{dCRK} = \sum {α}_{k} * {A}_{k} * ( {T}_{W , k} - {T}_{cyl} ) * \frac{{d}_{t}}{dCRK} ,$$

the technical work

$$\frac{{dW}_{t}}{dCRK} = - {p}_{cyl} \frac{{dV}_{cyl}}{dCRK} ,$$

the enthalpy flow entering via inlet valves

$$\frac{{dH}_{inlet}}{dCRK} = {\sum }_{k} {h}_{inlet , k} * \frac{{dm}_{inlet , k}}{dCRK} ,$$

the corresponding enthalpy flow exiting via outlet valves

$$\frac{{dH}_{outlet}}{dCRK} = \frac{{dm}_{outlet , k}}{dCRK} {\sum }_{k} {h}_{A , k} * \frac{{dm}_{outlet , k}}{dCRK} ,$$

and the leakage enthalpy flow

$$\frac{{dH}_{blowby}}{dCRK} = {h}_{blowby} * \frac{{dm}_{blowby , k}}{dCRK} .$$

As a simplification, this energy balance can be converted for example into a balance of the heat flows. Here, the relationship between the convective heat flow to the cylinder wall temperature, the heat flow transported through the cylinder wall by heat conduction and in turn the heat flow transmitted by convection to the coolant is established:

$${α}_{G} \cdot {A}_{G} \cdot ( {T}_{G} - {T}_{CW} ) = \frac{λ}{{s}_{CW}^{CW}} \cdot {A}_{CW} \cdot ( {T}_{CW} - {T}_{CW , cool} ) + {m}_{cyl} \cdot {c}_{cyl} \cdot \frac{dT}{{dt}^{CW}} = {α}_{coolant} \cdot {A}_{cool} \cdot ( {T}_{CW , cool} - {T}_{cool} ) .$$

Here, the following abbreviations are used:

α_{G}: mean heat transfer coefficient of the gas side,

A_{G}: effective heat flow cross section of the gas side,

T_{G}: mean temperature of the gas side (cylinder chamber),

λ_{CW}: thermal conductivity of the combustion chamber wall,

s_{CW}: (effective) thickness of the combustion chamber wall,

A_{CW}: effective heat flow cross section of the cylinder wall,

T_{CW}: mean cylinder wall temperature of the combustion chamber side,

T_{CW,cool}: mean cylinder wall temperature of the coolant side,

α_{coolant: heat transfer coefficient of the coolant,}

A_{cool}: effective area of the coolant side,

T_{cool}: coolant temperature,

M_{cyl}: effective mass of the cylinder,

C_{cyl}: specific heat capacity of the cylinder.

From this, a calculation model for the steady-state situation can be derived, which model is composed in principle of three parts. The first part is the determination of the gas-side model parameters. The third part is concerned with calculations from the thermal management. In the second part, said calculations are brought together by means of the calculation of the wall transitions.

$${α}_{G} {A}_{G} ( {T}_{G} - {T}_{CW} ) = \frac{{λ}_{CW}}{{d}_{CW}} {A}_{CW} ( {T}_{CW} - {T}_{CW , cool} ) = {α}_{coolant} {A}_{cool} ( {T}_{CW , cool} - {T}_{cool} )$$

The mean gas temperature T_{G} can be calculated with the knowledge of the cylinder pressure P_{cyl}, the swept volume V_{cyl}, the air mass MAF and the gas constant R:

$${T}_{G} = \frac{{P}_{cyl} \cdot {V}_{cyl}}{MAF \cdot R} \cdot {a}_{1} + {T}_{in} \cdot {a}_{2} .$$

Here, the inlet temperature Tᵢₙ must be taken into consideration. The parameters a1 and a2 must be empirically determined. Optionally, the exhaust-gas temperature may also be incorporated in weighted form into the equation by means of the parameter a3. The gas temperature may also be corrected using the lambda value, because the combustion temperature is relatively cool at lambda values < >1.

The indicated mean pressure P_{cyl} is calculated using the indicated engine torque TQI and the swept volume V_{cyl}

$${P}_{cyl} = \frac{4 \cdot π \cdot TQI}{{V}_{cyl}} .$$

The calculation of the heat transfer coefficient α_{G} in the combustion chamber may, according to Woschni, be determined as follows:

α_{G}=130·B^{-0.2}·P_{cyl}^{0.8}·T_{G}^{-0.53}·ν_{G}^{0.8}.

The speed of the charge movement is, in the first approach, approximated on the basis of the piston speed. In some embodiments, it is also possible for the charge movement resulting from swirl, tumble, etc. to be taken into consideration.

The thermal management of an internal combustion engine is highly complex owing to a multiplicity of hydraulic control elements (various pumps and switching valves). It is thus advantageous to resort to simplified models or estimations. One approach is dimensional analysis, for example by means of regression analysis on the basis of the Levenberg-Marquardt algorithm. On the basis of this empirical approach, the coolant speed and the kinematic viscosity can be estimated. This dependency may be approximated as a polynomial or as a characteristic map in the engine controller.

The Reynolds number Reₖ can subsequently be calculated from the internal diameter Dᵢ of the cooling channel and the coolant speed ν_{coolant}, and the kinematic viscosity n. The kinematic viscosity n is an expression for the internal friction of a liquid. The kinematic viscosity is the quotient of the dynamic viscosity and of the density of the liquid.

$${Re}_{k} = \frac{{D}_{i} \cdot {v}_{coolant}}{n}$$

The Prandtl number exhibits an intense temperature dependency and may also be determined as a polynomial expansion or with the aid of a characteristic map. From the Prandtl number and the Reynolds number, the Nusselt number can be ascertained.

From the Nusselt number Nu_{collant}, the thermal conductivity of the coolant λ and the diameter of the cooling channel Dᵢ, the heat transfer coefficient α_{coolant} can be calculated

$${α}_{coolant} = \frac{{Nu}_{coolant} \cdot λ ,}{{D}_{i}} .$$

As a final step, from these intermediate variables, the steady-state cylinder wall temperature T_{cyl,stat} is determined

$${T}_{cyl , stat} = \frac{{α}_{G} \cdot {T}_{G} + U \cdot {T}_{cool} ,}{{α}_{G} + U} .$$

Here, U represents the substitute thermal conductivity value

$$U = \frac{{α}_{G} \cdot ( {T}_{G} - {T}_{CW} ) ,}{{T}_{CW} - {T}_{cool )}} .$$

For the determination of the dynamic cylinder wall temperature T_{cyl}, the thermal inertia of the cylinder head must also be taken into consideration. Here, the parameter k is ascertained from the effective thermal mass of the cylinder and the specific heat capacity

T_{cyl}=(T_{cyl,stat}−T_{cyl,old})·k+T_{cyl,old}.

T_{cyl,old} denotes in this case the dynamic cylinder temperature from a preceding calculation cycle.

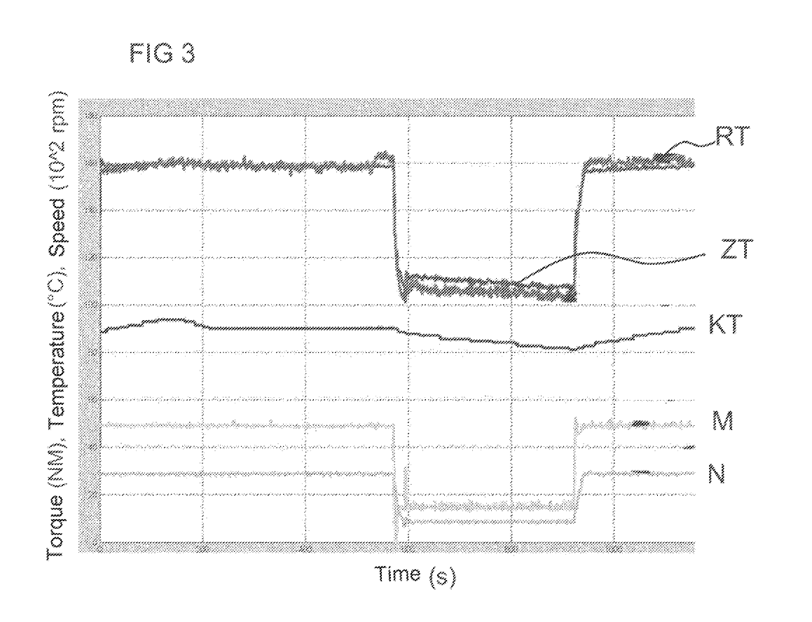

FIG. 3 shows a graph with values of ascertained cylinder wall temperatures ZT. The uppermost two lines are representative of the (dynamic) cylinder wall temperature ZT ascertained by means of the above cylinder wall model and a reference temperature RT ascertained by means of a sensor arrangement. Here, the reference temperature RT is the line with the more pronounced noise. The third line from the top is representative of the coolant temperature KT. The fourth line from the top is representative of the torque M, and the fifth line is representative of the speed N.

As can be seen in FIG. 3, the dynamic cylinder wall temperature ZT follows the reference temperature RT in the illustrated transient situation, whereas the coolant temperature KT falls only very slowly. If the injection time is determined only using parameters such as load and speed, then in the event of a change in the temperature, it is for example the case that the vaporization behavior of the fuel changes, and incomplete combustion occurs, because the parameters of load and speed are applicable only at certain combustion chamber temperatures. An exceedance of the particle limit values may consequently occur.

It is thus possible, through the use of the cylinder wall temperature ZT, to achieve an improvement in emissions in particular with regard to the particle count and particle size, in particular in relation to an ascertainment in a manner dependent on the coolant temperature KT. If the cylinder wall temperature ZT is ascertained independently of the exhaust-gas temperature, then no exact modeling of the exhaust-gas temperature, or an exhaust-gas temperature sensor, is needed. The above-described cylinder wall temperature model allows modular physical modeling. It is thus possible for intermediate variables to be determined in a component-dependent manner. This permits straightforward calibration of the cylinder wall temperature ZT, because no multi-dimensional dependencies have to be determined in characteristic maps for the ascertainment of the cylinder wall temperature ZT.

In some embodiments, a piston crown temperature of the cylinder may be ascertained, and the injection time may be ascertained in a manner dependent on the piston crown temperature. The piston crown temperature may for example likewise, similarly to the cylinder wall temperature, be ascertained by means of a suitable model. In particular, it is thus optionally also possible for the first value of the first characteristic map and the second value of the second characteristic map to be weighted in a manner dependent on the cylinder wall temperature and the piston crown temperature.

### LIST OF REFERENCE DESIGNATIONS

S1-S709 Steps
50 Control apparatus
KT Coolant temperature
M Torque
N Speed
RT Reference temperature
ZT Cylinder wall temperature

What is claimed is:

1. A method for setting injection timing for injection of a fuel into a combustion chamber of a cylinder of an internal combustion engine, the method comprising:
determining a torque of the internal combustion engine;
determining a speed of the internal combustion engine;
determining a cylinder wall temperature of the cylinder;
selecting the injection timing based at least on the cylinder wall temperature, the torque, and the speed; and
controlling an injection of fuel into the combustion chamber using the selected injection timing.

2. The method as claimed in claim 1, further comprising:
determining
a piston crown temperature of the cylinder; and
adapting the selected injection timing based on the piston crown temperature.

3. The method as claimed in claim 1, wherein:
selecting the injection timing includes referring to a first characteristic map provided for the internal combustion engine in a first operating mode to identify
a first value of the first characteristic map based on the torque and the speed;
applying a weighting factor to the first value based on the cylinder wall temperature; and
using the weighted first value to select the injection timing.

4. The method as claimed in claim 3, wherein:
selecting the injection timing includes referring to a second characteristic map provided for the internal combustion engine in a second operating mode which differs from the first operating mode;
determining a second value of the second characteristic map based on the torque and the speed;
applying a second weighted factor to the second value based on the cylinder wall temperature; and
using the weighted second value to select the injection timing.

5. The method as claimed in claim 4, wherein:
the first characteristic map corresponds to a normal operating mode; and
the second characteristic map corresponds to a load alteration of the internal combustion engine.

6. The method as claimed in claim 1, wherein determining the cylinder wall temperature using a predefined cylinder wall temperature model.

7. The method as claimed in claim 6, wherein the cylinder wall temperature model comprises a thermodynamic temperature model.

8. The method as claimed in claim 6, wherein the cylinder wall temperature represents dynamic cylinder wall temperature depending on a steady-state cylinder wall temperature.

9. The method as claimed in claim 6, wherein determining the cylinder wall temperature depends on an ascertained cylinder pressure, an ascertained swept volume of the cylinder, an ascertained air mass, and an ascertained indicated engine torque.

10. The method as claimed in claim 6, wherein determining the cylinder wall temperature depends on an ascertained exhaust-gas temperature.

11. The method as claimed in claim 6, wherein the cylinder wall temperature model depends on modular intermediate variables including: mean gas temperature in the cylinder chamber, indicated mean pressure of the cylinder, heat transfer coefficient in the combustion chamber, and steady-state cylinder wall temperature.

12. An apparatus for controlling an internal combustion engine, the apparatus comprising:
a processing unit;
a program;
a data memory; and
a communication interface;
wherein the program, when executed by the processing unit, selects an injection time for a fuel injector based on a torque of the internal combustion engine, a speed of the internal combustion engine, a cylinder wall temperature of the cylinder; and
controls an injection of fuel into the combustion chamber using the selected injection timing.
